(19) United States
(12) Patent Application Publication
(10) Pub. No.: US 2019/0236157 A1
(43) Pub. Date: Aug. 1, 2019

(54) MULTIDIMENSIONAL TARGETING OF QUESTIONS TO MEMBERS OF A COMMUNITY

(71) Applicant: Microsoft Technology Licensing, LLC, Redmond, WA (US)

(72) Inventors: Nikhil Agarwal, Bengaluru (IN); Pankhuri Goyal, Bengaluru (IN); Sachin Kakkar, Bengaluru (IN)

(73) Assignee: Microsoft Technology Licensing, LLC, Redmond, WA (US)

(21) Appl. No.: 15/884,064

(22) Filed: Jan. 30, 2018

(51) Int. Cl. G06F 17/30

(52) U.S. Cl. CPC G06F 17/3053; G06F 17/30867; G06F 17/30592

(57) ABSTRACT

The disclosed embodiments provide a system for processing data. During operation, the system obtains a set of questions from a community of members. Next, the system uses a set of tags for each question and member attributes for a member of the community to calculate a relevance score representing a relevance of the question to the member. The system then combines the relevance score with additional scores for the member to obtain an overall score between the question and the member. Finally, the system ranks the set of questions by the overall scores and outputs the ranked set of questions to the member for use in obtaining answers to the set of questions from the member.

### BACKGROUND

### Field

The disclosed embodiments relate to question-and-answer (Q&A) systems. More specifically, the disclosed embodiments relate to techniques for performing multidimensional targeting of questions to members of a community.

### Related Art

Online networks may include nodes representing entities such as individuals and/or organizations, along with links between pairs of nodes that represent different types and/or levels of social familiarity between the entities represented by the nodes. For example, two nodes in an online network may be connected as friends, acquaintances, family members, and/or professional contacts. Online networks may further be tracked and/or maintained on web-based networking services, such as online professional networks that allow the entities to establish and maintain professional connections, list work and community experience, endorse and/or recommend one another, run advertising and marketing campaigns, promote products and/or services, and/or search and apply for jobs.

In turn, users and/or data in online professional networks may facilitate other types of activities and operations. For example, sales professionals may use an online professional network to locate prospects, maintain a professional image, establish and maintain relationships, and/or engage with other individuals and organizations. Similarly, recruiters may use the online professional network to search for candidates for job opportunities and/or open positions. At the same time, job seekers may use the online professional network to enhance their professional reputations, conduct job searches, reach out to connections for job opportunities, and apply to job listings. Consequently, use of online professional networks may be increased by improving the data and features that can be accessed through the online professional networks.

### BRIEF DESCRIPTION OF THE FIGURES

FIG. 1 shows a schematic of a system in accordance with the disclosed embodiments.

FIG. 2 shows a system for processing data in accordance with the disclosed embodiments.

FIG. 3 show the calculation of a set of scores between a question and a member in accordance with the disclosed embodiments.

FIG. 4 shows a flowchart illustrating the processing of data in accordance with the disclosed embodiments.

FIG. 5 shows a flowchart illustrating a process of calculating a set of scores between a question and a member in accordance with the disclosed embodiments.

FIG. 6 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

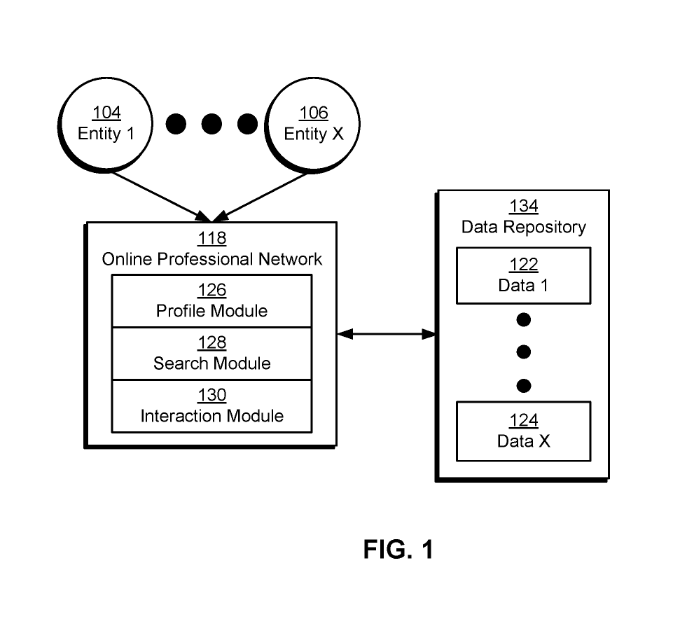

The disclosed embodiments provide a method, apparatus, and system for processing data. As shown in FIG. 1, the data may be associated with a user community, such as an online professional network 118 that is used by a set of entities (e.g., entity 1 104, entity x 106) to interact with one another in a professional and/or business context.

The entities may include users that use online professional network 118 to establish and maintain professional connections, list work and community experience, endorse and/or recommend one another, search and apply for jobs, and/or perform other actions. The entities may also include companies, employers, and/or recruiters that use online professional network 118 to list jobs, search for potential candidates, provide business-related updates to users, advertise, and/or take other action.

More specifically, online professional network 118 includes a profile module 126 that allows the entities to create and edit profiles containing information related to the entities' professional and/or industry backgrounds, experiences, summaries, job titles, projects, skills, and so on. Profile module 126 may also allow the entities to view the profiles of other entities in online professional network 118.

Profile module 126 may also include mechanisms for assisting the entities with profile completion. For example, profile module 126 may suggest industries, skills, companies, schools, publications, patents, certifications, and/or other types of attributes to the entities as potential additions to the entities' profiles. The suggestions may be based on predictions of missing fields, such as predicting an entity's industry based on other information in the entity's profile. The suggestions may also be used to correct existing fields, such as correcting the spelling of a company name in the profile. The suggestions may further be used to clarify existing attributes, such as changing the entity's title of “manager” to “engineering manager” based on the entity's work experience.

Online professional network 118 also includes a search module 128 that allows the entities to search online professional network 118 for people, companies, jobs, and/or other job- or business-related information. For example, the entities may input one or more keywords into a search bar to find profiles, job postings, articles, and/or other information that includes and/or otherwise matches the keyword(s). The entities may additionally use an “Advanced Search” feature in online professional network 118 to search for profiles, jobs, and/or information by categories such as first name, last name, title, company, school, location, interests, relationship, skills, industry, groups, salary, experience level, etc.

Online professional network 118 further includes an interaction module 130 that allows the entities to interact with one another on online professional network 118. For example, interaction module 130 may allow an entity to add other entities as connections, follow other entities, send and receive emails or messages with other entities, join groups, and/or interact with (e.g., create, share, re-share, like, and/or comment on) posts from other entities.

In another example, interaction module 130 includes a question-and-answer (Q&A) service that allows entities to post questions and/or answers to questions by other entities. The Q&A service may also allow the entities to upvote, downvote, like, hide, and/or rate the questions and/or answers; comment on or share the questions and/or answers; follow, connect with, hide, and/or block authors of the questions and/or answers; and/or perform other actions or interactions associated with the questions and/or answers. In turn, the entities may use the Q&A service to obtain and/or provide guidance, perspectives, and/or facts related to careers, education, employment, industries, skills, networking, and/or other topics associated with online professional network 118.

Those skilled in the art will appreciate that online professional network 118 may include other components and/or modules. For example, online professional network 118 may include a homepage, landing page, and/or content feed that provides the latest posts, articles, and/or updates from the entities' connections and/or groups to the entities. Similarly, online professional network 118 may include features or mechanisms for recommending connections, job postings, articles, and/or groups to the entities.

In one or more embodiments, data (e.g., data 1 122, data x 124) related to the entities' profiles and activities on online professional network 118 is aggregated into a data repository 134 for subsequent retrieval and use. For example, each profile update, profile view, connection, follow, post, comment, like, share, search, click, message, interaction with a group, address book interaction, response to a recommendation, purchase, and/or other action performed by an entity in online professional network 118 may be tracked and stored in a database, data warehouse, cloud storage, and/or other data-storage mechanism providing data repository 134.

In one or more embodiments, data in data repository 134 is used to rank and/or target questions for answering by members of online professional network 118. As mentioned above, the questions and/or answers to the questions may be submitted and/or posted to a Q&A service provided by interaction module 130. In turn, the questions may be targeted to members based on multiple attributes and/or dimensions that include the authors of the questions, the content of the questions, and/or potential respondents to the questions.

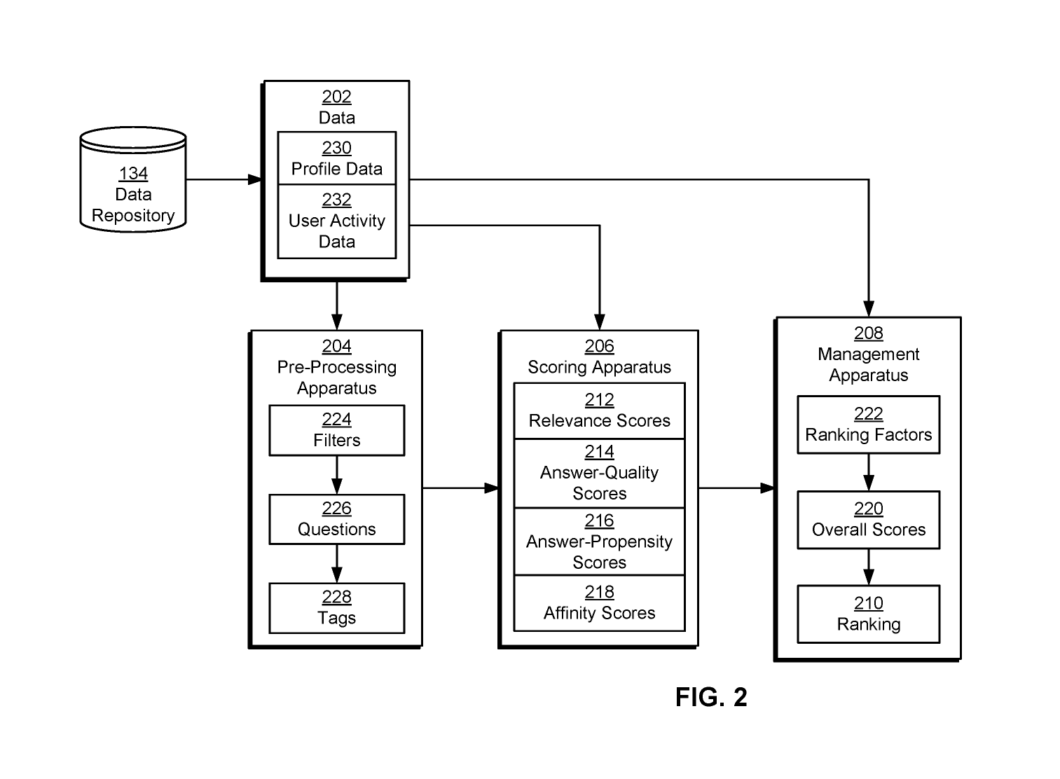

As shown in FIG. 2, a system for targeting questions to members of a community (e.g., online professional network 118 of FIG. 1) utilizes data 202 from data repository 134, which includes profile data 230 for members of the community, as well as user activity data 232 that tracks the members' activity within and/or outside the community. Profile data 230 may include data associated with member profiles in the community. For example, profile data 230 for an online professional network may include a set of attributes for each user, such as demographic (e.g., gender, age range, nationality, location, language), professional (e.g., job title, professional summary, professional headline, employer, industry, experience, skills, seniority level, professional endorsements), social (e.g., organizations to which the user belongs), and/or educational (e.g., degree, university attended, courses, fellowships, etc.) attributes. Profile data 230 may also include a set of groups to which the user belongs, the user's contacts and/or connections, patents or publications associated with the user, and/or other data related to the user's interaction with the community.

Attributes of the members may be matched to a number of member segments, with each member segment containing a group of members that share one or more common attributes. For example, member segments in the social network may be defined to include members with the same industry, title, location, and/or language.

Connection information in profile data 230 may additionally be combined into a graph, with nodes in the graph representing entities (e.g., users, schools, companies, locations, etc.) in the community. In turn, edges between the nodes in the graph may represent relationships between the corresponding entities, such as connections between pairs of members, education of members at schools, employment of members at companies, following of a member or company by another member, business relationships and/or partnerships between organizations, and/or residence of members at locations.

User activity data 232 may include records of member interactions with one another and/or content associated with the community. For example, user activity data 232 may be used to track impressions, clicks, likes, dislikes, shares, hides, comments, posts, updates, conversions, and/or other user interaction with content in the community. User activity data 232 may also track other types of activity, including connections, messages, job searches, job applications, recruiter interactions, and/or interaction with groups or events. User activity data 232 may further include social validations of skills, seniorities, job titles, and/or other profile attributes, such as endorsements, recommendations, ratings, reviews, collaborations, discussions, articles, posts, comments, shares, and/or other member-to-member interactions that are relevant to the profile attributes.

User activity data 232 may further track activities related to a Q&A service provided by or through the community. For example, user activity data 232 may include questions 226 and/or answers to questions 226 posted to the Q&A service. User activity data 232 may also track other actions related to questions 226 and/or the corresponding answers, including views, clicks, comments, upvotes, downvotes, ratings, shares, ignores, and/or hides of the questions, answers, and/or authors of the questions or answers. User activity data 232 may additionally include member preferences related to questions 226 and/or the answers, such as explicit feedback from a member regarding the relevance or lack of relevance of questions 226 displayed to the member and/or the member's subscriptions to specific topics or categories of questions 226 in the Q&A service. User activity data 232 may further include records of follows, connections, and/or other member-to-member interactions that result from the posted questions 226 and/or answers.

Profile data 230, user activity data 232, and/or other data 202 in data repository 134 may be standardized before the data is used by components of the system. For example, skills in profile data 230 and/or user activity data 232 may be organized into a hierarchical taxonomy that is stored in data repository 134 and/or another repository. The taxonomy may model relationships between skills (e.g., “Java programming” is related to or a subset of “software engineering”) and/or standardize identical or highly related skills (e.g., “Java programming,” “Java development,” “Android development,” and “Java programming language” are standardized to “Java”).

Such standardization of data 202 may facilitate analysis of the data by statistical models and/or machine learning techniques, as well as use of the member attributes with products in and/or associated with the social network. For example, transformation of a set of related and/or synonymous skills into the same standardized skill of “Java” may improve the performance of a statistical model that uses the skills to generate recommendations, scores, predictions, classifications, and/or other output that is used to modulate features and/or interactions in the social network. In another example, a search for members with skills that match “Java development” may be matched to a group of members with the same standardized skill of “Java,” which is returned in lieu of a smaller group of members that specifically list “Java development” as a skill. In a third example, standardization of a first company's name into the name of a second company that acquired the first company may allow a link to the first company in a member profile to be redirected to a company page for the second company in the social network.

In one or more embodiments, a pre-processing apparatus 204 includes functionality to generate a set of standardized tags 228 for questions 226 posted to the Q&A service. Each tag includes one or more keywords, n-grams, and/or other portions of text from a corresponding question. The tag also includes an attribute associated with the portion of text, such as a category to which the text belongs. For example, standardized tags for questions posted to an online professional network may include words and/or phrases that are associated with attributes such as skills, titles, companies, industries, schools, locations, interests, seniorities, and/or groups from profile data 230 and/or user activity data 232 in the online professional network.

Each tag may also be associated with a predicted likelihood that a given question includes the tag. For example, a portion of the question that is identified as containing a tag and a corresponding attribute may include a value from 0 to 1 representing the confidence in the identified tag and/or attribute.

To generate tags 228 for a given question, pre-processing apparatus 204 may use natural-language-processing (NLP) techniques, topic mining techniques, machine-learning models, and/or other text-analytics techniques to identify portions of text in questions 226, match the portions to standardized data in data repository 134 and/or another repository, and/or determine the confidence in the corresponding tags 228. Pre-processing apparatus 204 may then annotate the question with tags 228, store tags 228 with the question in data repository 134 and/or another repository, and/or otherwise associate tags 228 with the question.

Prior to generating tags 228 for questions 226, pre-processing apparatus 204 may apply a set of filters 224 to questions 226. Filters 224 may be used to remove content that is not appropriate for matching to the members from questions 226. For example, filters 224 may be used to prevent questions 226 with promotional and/or offensive content from being posted in the Q&A service. In another example, filters 224 may identify and flag factual questions 226 for answering by bots and/or other automated mechanisms instead of by human users of the Q&A service.

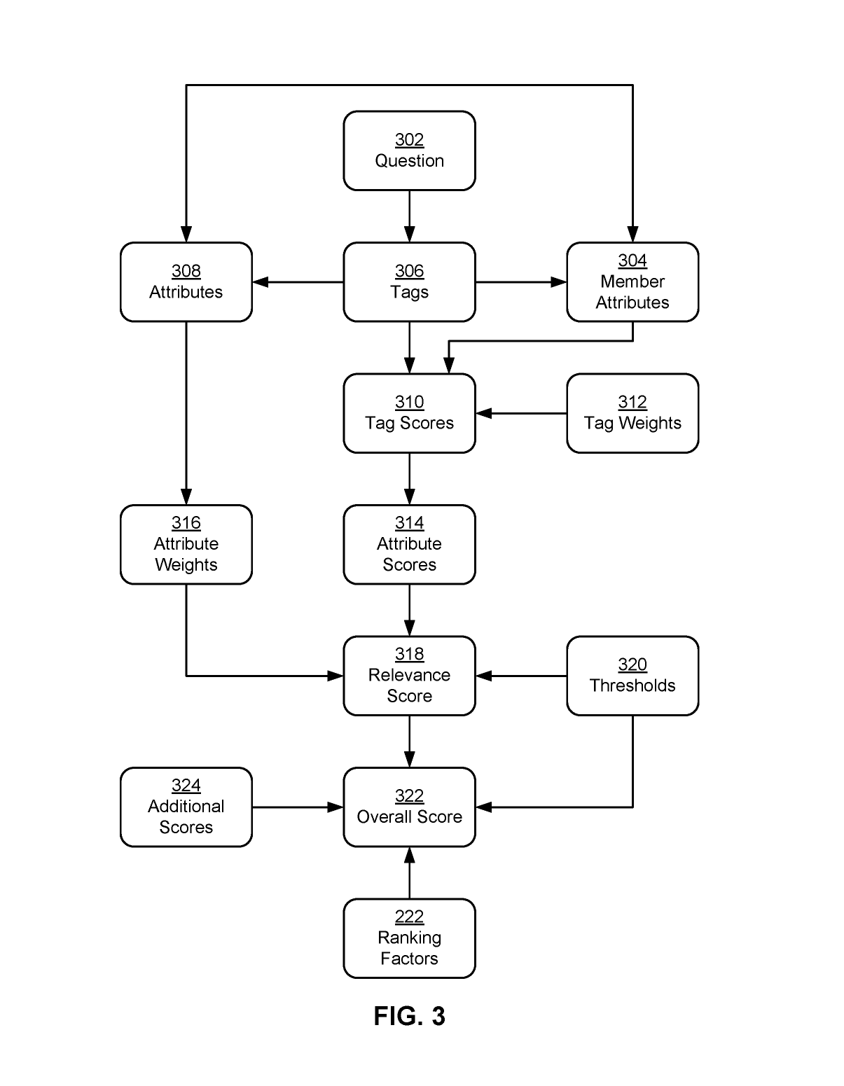

To target questions 226 to members of the community, a scoring apparatus 206 calculates a set of scores associated with questions 226 and/or the members. The scores include relevance scores 212 between the members and questions 226, with each relevance score representing the relevance of a question to a given member. To calculate relevance scores 212, scoring apparatus 206 may match tags 228 in the question to member attributes from profile data 230 and/or user activity data 232 associated with the member. For example, scoring apparatus 206 may match skills, titles, companies, industries, schools, locations, interests, seniorities, groups, and/or other types or categories of tags 228 in the question to the corresponding member attributes of the member. Scoring apparatus 206 may then combine tags 228 that are found in both the question and the member attributes with a set of weights to calculate a relevance score between the question and the member, as described in further detail below with respect to FIG. 3.

Scoring apparatus 206 also calculates a set of answer-quality scores 214 and a set of answer-propensity scores 216 for the members. Each answer-quality score and answer-propensity score may be calculated for a given member independently of the authors and/or content of questions 226. The answer-quality score for a member represents the expected and/or predicted quality of the member's answers to questions 226. As a result, the answer-quality score may be calculated from features such as the background of the member (e.g., amount of professional or industry experience, seniority, educational attainment, etc.), the quality of the member's previous answers (e.g., upvotes, downvotes, ratings, answer length, number of answers, number of answers flagged as inappropriate, etc.), and/or the member's type of account or status within the community (e.g., highly connected member, influencer, etc.).

The answer-propensity score represents the general likelihood of the member in answering questions 226 posted to the community. As a result, the answer-propensity score may be calculated from features that measure the member's activity within the community, such as the member's recent and/or historic activity with creating or sharing articles, posts, comments, content feed interactions, messages, and/or other types of content within the community.

Scoring apparatus 206 further calculates a set of affinity scores 218 between authors of questions 226 and other members of the community. Each affinity score may represent the likelihood that a member answers a question given the author of the question. As a result, the affinity score may be calculated using features that reflect the relationship or commonality between the member and author, such as the network distance between the member and author in a social network (e.g., online professional network 118 of FIG. 1), the type of relationship between the member and author (e.g., connected, following, friends, colleagues, etc.), overlap in the backgrounds of the member and author (e.g., same or similar industries, titles, companies, schools, etc.), and/or historic interaction between the member and author (e.g., messages, comments, previous answers to the author's questions by the member, etc.). The affinity score may also account for privacy settings for the member and/or author and/or blocking of content and/or interaction between pairs of members.

Scoring apparatus 206 then combines relevance scores 212, answer-quality scores 214, answer-propensity scores 216, and/or affinity scores 218 into a set of overall scores 220 for questions 226. For example, scoring apparatus 206 may multiply and/or add the scores with one another, combine the scores with a set of weights, and/or apply one or more thresholds to the scores to produce overall scores 220. As a result, overall scores 220 may be generated by combining multiple dimensions representing relevance, answer quality, answer propensity, member-to-member affinity, and/or other factors that influence the member's response to questions 226 and/or the user experience with the Q&A service.

After overall scores 220 are calculated, a management apparatus 208 generates a ranking 210 of questions 226 by overall scores 220 for a given member and displays ranking 210 to the member. For example, management apparatus 208 may rank questions 226 by descending order of overall scores 220, so that questions 226 with higher overall scores are positioned higher in ranking 210 than questions 226 with lower overall scores. Management apparatus 208 may then display ranking 210 in a user interface, email, notification, message, and/or another communication mechanism with the member. In turn, the member may use ranking 210 to browse, view, and/or click on questions 226; generate answers to specific questions 226; comment on questions 226 and/or other answers to questions 226; upvote, downvote, and/or rate questions 226 and/or the corresponding answers; and/or otherwise interact with questions 226, answers, and/or members within the Q&A service.

Prior to displaying ranking 210 to the member, management apparatus 208 uses a number of ranking factors 222 to adjust overall scores 220 and/or ranking 210. Ranking factors 222 may include signals, attributes, and/or data 202 that are not used to calculate relevance scores 212, answer-quality scores 214, answer-propensity scores 216, affinity scores 218, and/or overall scores 220.

First, ranking factors 222 may include the member's responses (e.g., views, answers, ignores, hides, etc.) to previously outputted questions 226 and/or feedback related to the relevance of the previously outputted questions 226 (e.g., flagging a question as relevant or irrelevant). Ranking factors 222 may similarly include explicit preferences for specific types of content in questions 226 (e.g., subscriptions to specific topics in the Q&A service) and/or implicit interests based on group memberships, likes, follows, and/or other types of activity within the community. In turn, overall scores 220 of questions 226 with tags 228 that are identified as lacking relevance to the member may be reduced. Conversely, popular (e.g., highly rated, liked, commented, etc.) answers from the member to previous questions 226 may be identified, and newer questions 226 with tags 228 that have significant overlap with the previous questions 226 may be increased.

Ranking factors 222 may also, or instead, include impression discounting and/or diversification of questions 226 in ranking 210. For example, a question's overall score and/or position in ranking 210 may be decreased based on the number of times the member has previously seen the question. In another example, overall scores 220 and/or ranking 210 may be adjusted to increase the diversity of authors of questions 226 in ranking 210 and/or reduce the number of questions 226 from the same author in ranking 210. Impression discounting and/or diversification of questions 226 in ranking 210 may thus allow questions 226 from relatively unknown or unconnected authors and/or questions 226 with tags 228 to which the member has not been previously exposed to be outputted to the member.

Ranking factors 222 may further include Q&A-related interactions between the member and his/her close network (e.g., first-degree connections, second-degree connections, etc.) within the community. For example, the member's previous answers, comments, shares, likes, and/or other interaction with previously posted questions 226 by the member's connections in the community may be tracked. Tags 228 and/or other attributes may then be used to identify questions 226 that are semantically similar to the previously posted questions 226, and overall scores 220 for the identified questions 226 may be increased.

By targeting questions 226 to members based on a variety of different scores and/or ranking factors 222, the system of FIG. 2 may personalize the members' interaction with questions 226 based on the members' preferences, interests, backgrounds, and/or relationships. In turn, the system may increase the members' likelihood of producing answers to questions 226, the quality of the answers, and/or member engagement with the Q&A service. Consequently, such comprehensive, end-to-end targeting of questions 226 to members improves the performance and use of technologies for providing Q&A services, generating user recommendations, and/or connecting users via network-enabled devices.

Those skilled in the art will appreciate that the system of FIG. 2 may be implemented in a variety of ways. First, pre-processing apparatus 204, scoring apparatus 206, management apparatus 208, and/or data repository 134 may be provided by a single physical machine, multiple computer systems, one or more virtual machines, a grid, one or more databases, one or more filesystems, and/or a cloud computing system. Pre-processing apparatus 204, scoring apparatus 206, and management apparatus 208 may additionally be implemented together and/or separately by one or more hardware and/or software components and/or layers. For example, pre-processing apparatus 204, scoring apparatus 206, and/or management apparatus 208 may be provided as services or features within an online community and/or separately from the online community. Moreover, various components of the system may be configured to execute in an offline, online, and/or nearline basis to perform different types of processing related to filtering and tagging questions 226, generating scores associated with questions 226 and/or members, and/or producing and/or updating rankings of questions 226 by the scores.

Second, a variety of techniques may be used to calculate and/or adjust scores and/or rankings of questions 226 for the members. For example, relevance scores 212, answer-quality scores 214, answer-propensity scores 216, affinity scores 218, and/or overall scores 220 may be calculated, combined, and/or adjusted using regression models, artificial neural networks, support vector machines, decision trees, Bayesian networks, clustering techniques, collaborative filtering techniques, text-mining models, hierarchical models, ensemble models, and/or other types of machine-learning models.

FIG. 3 show the calculation of a set of scores between a question 302 and a member in accordance with the disclosed embodiments. As discussed above, question 302 may include a number of tags 306 that represent words, phrases, and/or other portions of question 302 that are identified as having semantic importance. Tags 306 may also be associated with attributes 308 that classify and/or categorize tags 306 within a given community of members. For example, tags 306 for questions posted to an online professional network (e.g., online professional network 118 of FIG. 1) may be associated with attributes 308 such as skills, titles, companies, industries, schools, locations, interests, seniorities, and/or groups.

After tags 306 and the associated attributes 308 are identified for question 302, tags 306 and attributes 308 are matched to a number of member attributes 304 for a member. For example, tags 306 associated with a given attribute (e.g., skills mentioned in question 302) may be matched to the content of a corresponding member attribute (e.g., skills listed in the member's profile) to identify any overlap between tags 306 and the content of the member attribute (e.g., skills that are both mentioned in question 302 and included in the member's profile).

In turn, a set of tag scores 310 is calculated for tags 306 that are matched to member attributes 304 of the member. Tag scores 310 may be based on the uniqueness of the corresponding tags 306 across the community of members. For example, a tag score for a tag may be calculated as the inverse of the number of members with that tag in the corresponding member attribute (e.g., the number of members with a given skill listed in their profiles, the number of members in a given industry, the number of members that have worked at a given company, the number of members in a certain location, etc.).

Tag scores 310 for tags 306 that are matched to member attributes 304 may then be combined with tag weights 312 for the same tags 306 to generate a set of attribute scores 314 for attributes 308 to which tags 306 belong. For example, each attribute score may be calculated as a linear combination of tag scores 310 and tag weights 312 for tags 306 associated with the corresponding attribute. The tag weight for a given tag may be selected using data-analysis techniques that characterize the relative importance of the tag within the attribute. Thus, a tag with a higher tag weight may be associated with higher prominence and/or importance in the community and/or for the member than a tag with a lower tag weight. The tag weight may also, or instead, represent the likelihood that the corresponding tag is found in question 302.

In turn, attribute scores 314 may be combined with attribute weights 316 for the corresponding attributes 308 in question 302 to produce a relevance score 318 between the member and question 302. For example, relevance score 318 may be calculated as a linear combination of attribute scores 314 and the corresponding attribute weights 316. Like tag weights 312, attribute weights 314 may reflect the relative importance and/or significance of the corresponding attributes and/or the predicted likelihood that the attributes are found in question 302. For example, an attribute with higher semantic importance (e.g., a company) may be assigned a higher attribute weight than an attribute with lower semantic importance (e.g., an industry). In another example, an attribute may have an attribute weight that is set to the predicted likelihood that the attribute is found in question 302.

One or more thresholds 320 are also applied to relevance score 318 and/or one or more components of relevance score 318. For example, thresholds 320 may include a threshold for a minimum tag weight and/or attribute weight used to calculate relevance score 318. Thus, a tag and/or attribute with a corresponding weight that falls below the threshold may be omitted from the calculation of relevance score 318. If all attribute weights 316 and/or tag weights 312 for question 302 fall below the threshold, calculation of relevance score 318 may be omitted for question 302, and question 302 may be flagged as a “generic” question that is equally relevant to and thus “targeted” to all members.

In a second example, thresholds 320 may include a maximum difference between tag weights 312 and/or attribute weights 316. Thus, a tag and/or attribute with a corresponding weight that is less than the highest weight by more than the maximum difference may be omitted from inclusion in relevance score 318.

In a third example, thresholds 320 include a requirement that at least one tag in attributes 308 identified in question 302 is found in the corresponding member attributes 304 for the member. Thus, a question with attributes of “skill” and “company” and tags of “C,” “C++,” and “Java” for “skill” and tags of “Microsoft” and “LinkedIn” may include a calculated relevance score 318 for all members that list at least one of the skills and have worked in at least one of the two companies.

Relevance score 318 is then combined with a number of additional scores 324 to obtain an overall score 322 between the member and question 302. As mentioned above, additional scores 324 may include an answer-quality score representing a quality of answers from the member, an answer-propensity score representing a general likelihood of answering questions by the member, and/or an affinity score representing a likelihood of obtaining an answer to the question from the member given an author of the question.

To calculate overall score 322, some or all additional scores 324 may be summed, and the summed additional scores 324 may be multiplied by relevance score 318. For example, overall score 322 may be calculated by multiplying relevance score 318 by the sum of the answer-quality score and answer-propensity score. One or more thresholds 320 may also be applied to overall score 322 and/or one or more components of overall score 322. For example, a threshold may be applied to the affinity score between the member and the author of question 302 so that overall score 322 is calculated for question 302 only when the affinity score exceeds the threshold. Alternatively, the threshold may be omitted for authors that are new members of the community and/or authors that have relatively small networks within the community.

Overall score 322 may optionally be normalized so that overall score 322 spans a certain range. For example, a negative logarithm may be applied to a value of overall score 322 to map overall score 322 to a different range of values.

Finally, overall score 322 may be adjusted based on ranking factors 222 associated with previous interactions and/or preferences between the member and questions and/or other content in the community. Overall score 322 may then be used to rank question 302 with other questions for targeting to the member, as discussed above.

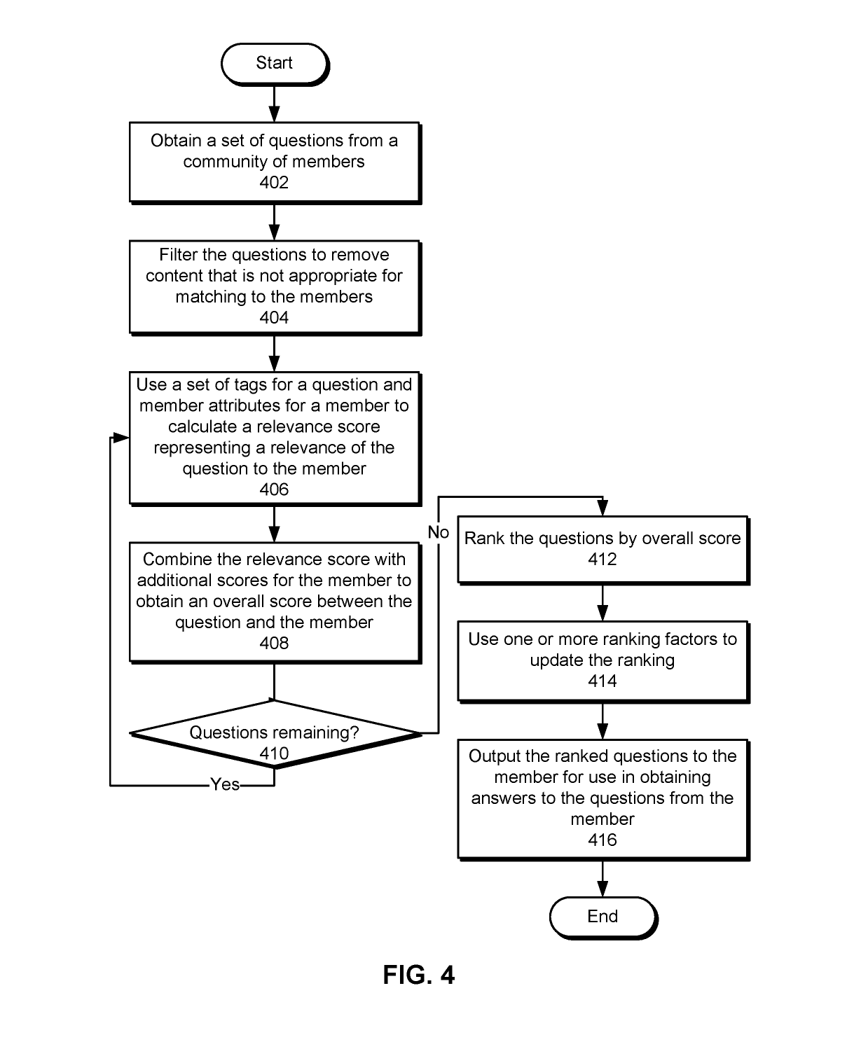

FIG. 4 shows a flowchart illustrating the processing of data in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

Initially, a set of questions from a community of members is obtained (operation 402). For example, the questions may be posted to an online forum, a Q&A service, and/or another centralized or distributed mechanism for enabling communication among the members. The questions may be related to various topics, categories, and/or fields associated with the community. For example, questions may be posted to an online professional network under topics related to jobs, careers, industries, skills, companies, locations, interests, groups, and/or other subjects that are relevant to professional or business endeavors.

Next, the questions are filtered to remove content that is not appropriate for matching to the members (operation 404). For example, the questions may be filtered to remove promotional content, offensive content, and/or factual questions that can be answered by non-human entities.

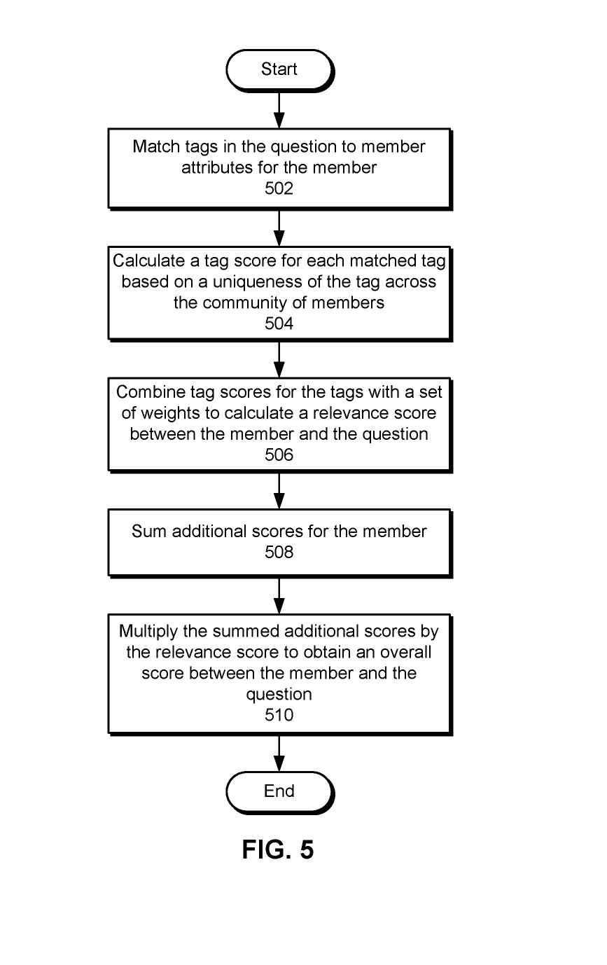

Each question is then analyzed for targeting to a member of the community. In particular, a set of tags for the question and member attributes for the member are used to calculate a relevance score representing a relevance of the question to the member (operation 406). The relevance score is then combined with additional scores for the member to obtain an overall score between the question and the member (operation 408). Calculating scores between questions and members is described in further detail below with respect to FIG. 5.

Operations 406-408 may be repeated for remaining questions (operation 410) to be matched to the members. For example, scores may be calculated for questions received over a given period (e.g., the last hour, the last day, etc.) that pass the filters in operation 404. The scores may also be calculated on a nearline and/or offline basis.

The questions are then ranked by overall score (operation 412). For example, the questions may be ranked in descending order of overall score, so that questions with higher overall scores are higher in the ranking than questions with lower overall scores. One or more ranking factors are also used to update the ranking (operation 414). For example, the scores and/or ranking may be adjusted to account for responses to previous questions outputted to the member, previous views of a question, an author of the question, previous interaction between the member and the author an explicit member preference, and/or an implicit member preference.

Finally, the ranking is outputted to the member for use in obtaining answers to the questions from the member (operation 416). For example, the ranking may be displayed to the member during access to the community by the member, included in an email or notification to the member, and/or otherwise presented to the member. Because the questions are ordered based on criteria that potentially increase the member's engagement with the questions and/or the relevance of the questions to the member, the member may be more likely to answer and/or provide high-quality answers to highly ranked questions than if the member were presented a randomly ordered list of questions.

FIG. 5 shows a flowchart illustrating a process of calculating a set of scores between a question and a member in accordance with the disclosed embodiments. In one or more embodiments, one or more of the steps may be omitted, repeated, and/or performed in a different order. Accordingly, the specific arrangement of steps shown in FIG. 5 should not be construed as limiting the scope of the embodiments.

First, tags for the question are matched to corresponding member attributes of the member (operation 502). For example, a set of tags may be obtained for each attribute associated with the question. The corresponding member attribute may then be analyzed to determine if any of the tags are found in the content of the member attribute.

Next, a tag score for each matched tag is calculated based on a uniqueness of the tag across the community of members (operation 504). For example, the tag score may be calculated as the inverse of the number of members with that tag in the corresponding member attribute.

Tag scores for the tags are then combined with a set of weights to calculate a relevance score between the member and the question (operation 506). The weights may include tag weights associated with the tags and/or attribute weights associated with attributes under which the tags are grouped. As a result, the relevance score may be calculated as a linear combination of the tag scores and corresponding weights. The relevance score may also be calculated by applying one or more thresholds to the tags, tag scores, and/or weights.

Additional scores for the member are then summed (operation 508), and the summed additional scores are multiplied by the relevance score to obtain an overall score between the member and the question (operation 510). One or more thresholds may also be applied to the additional scores during calculation of the overall score. For example, an answer-quality score and answer-propensity score may be summed and subsequently multiplied by the relevance score to produce the overall score. If an affinity score exists between the member and the author of the question (e.g., if the member and author have any historic interaction or relationship), a threshold may be applied to the affinity score, and the overall score may be calculated or maintained if the affinity score exceeds the threshold.

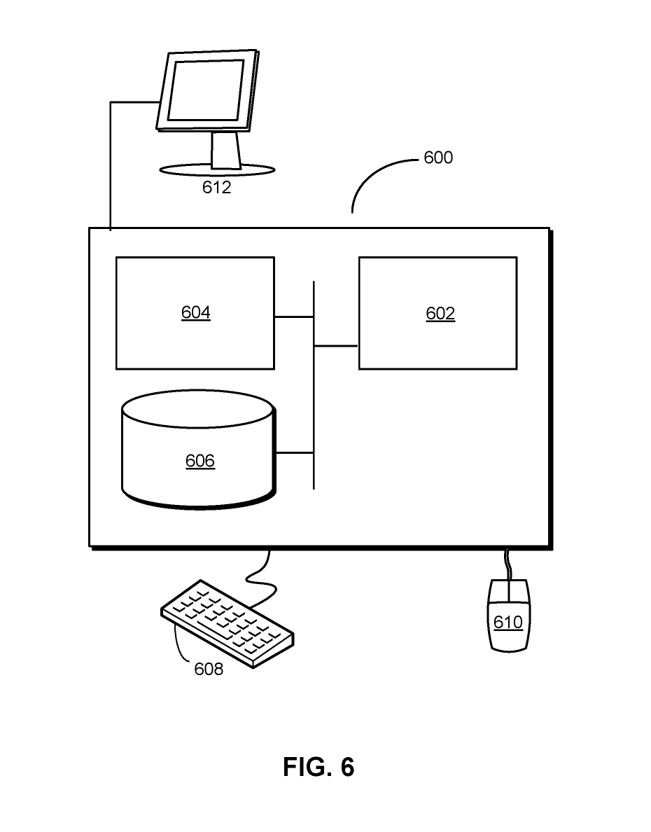

FIG. 6 shows a computer system 600 in accordance with the disclosed embodiments. Computer system 600 includes a processor 602, memory 604, storage 606, and/or other components found in electronic computing devices. Processor 602 may support parallel processing and/or multi-threaded operation with other processors in computer system 600. Computer system 600 may also include input/output (I/O) devices such as a keyboard 608, a mouse 610, and a display 612.

Computer system 600 may include functionality to execute various components of the present embodiments. In particular, computer system 600 may include an operating system (not shown) that coordinates the use of hardware and software resources on computer system 600, as well as one or more applications that perform specialized tasks for the user. To perform tasks for the user, applications may obtain the use of hardware resources on computer system 600 from the operating system, as well as interact with the user through a hardware and/or software framework provided by the operating system.

In one or more embodiments, computer system 600 provides a system for processing data. The system includes a pre-processing apparatus, a scoring apparatus, and a management apparatus, one or more of which may alternatively be termed or implemented as a module, mechanism, or other type of system component. The pre-processing apparatus obtains a set of questions from a community of members and generates a set of tags for the questions. Next, the scoring apparatus uses tags for each question and member attributes for a member to calculate a relevance score representing a relevance of the question to a member in the community. The scoring apparatus then combines the relevance score with additional scores for the member to obtain an overall score between the question and the member. Finally, the management apparatus ranks the set of questions by the overall score and outputs the ranked set of questions to the member for use in obtaining answers to the set of questions from the member.

In addition, one or more components of computer system 600 may be remotely located and connected to the other components over a network. Portions of the present embodiments (e.g., pre-processing apparatus, scoring apparatus, management apparatus, data repository, online community, Q&A service, etc.) may also be located on different nodes of a distributed system that implements the embodiments. For example, the present embodiments may be implemented using a cloud computing system that performs multidimensional targeting of questions to a set of remote members.

By configuring privacy controls or settings as they desire, members of a social network, online professional network, or other user community that may use or interact with embodiments described herein can control or restrict the information that is collected from them, the information that is provided to them, their interactions with such information and with other members, and/or how such information is used. implementation of these: embodiments is not intended to supersede or interfere with the members' privacy settings.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
obtaining a set of questions from a community of members;
for each question in the set of questions, performing the following operations on one or more computer systems:
using a set of tags for the question and member attributes for a member of the community to calculate a relevance score representing a relevance of the question to the member; and
combining the relevance score with additional scores for the member to obtain an overall score between the question and the member, wherein the additional scores are calculated based on interaction of the member with the community;
ranking the set of questions by the overall scores; and
outputting the ranked set of questions to the member for use in obtaining answers to the set of questions from the member.

2. The method of claim 1, further comprising:
using one or more ranking factors to update the ranked set of questions prior to outputting the ranked set of questions to the member.

3. The method of claim 2, wherein the one or more ranking factors comprise at least one of:
responses to previous questions outputted to the member;
previous views of a question;
an author of the question;
previous interaction between the member and the author;
an explicit member preference; and
an implicit member preference.

4. The method of claim 1, wherein using the set of tags for the question and the member attributes for the member to calculate the relevance score representing the relevance of the question to the member comprises:
matching a subset of the tags for the question to one or more of the member attributes for the member;
for each tag in the subset of the tags, calculating a tag score for the tag based on a uniqueness of the tag across the community of members; and
combining tag scores for the subset of the tags with a set of weights to calculate the relevance score for the question.

5. The method of claim 4, wherein the set of weights comprises at least one of:
a first weight associated with a tag; and
a second weight associated with a member attribute represented by the tag.

6. The method of claim 1, wherein combining the relevance score with the additional scores for the member to obtain the overall score between the question and the member comprises:
summing the additional scores; and
multiplying the summed additional scores by the relevance score to obtain the overall score.

7. The method of claim 1, wherein the additional scores comprise an answer-quality score representing a quality of answers from the member.

8. The method of claim 1, wherein the additional scores comprise an answer-propensity score representing a general likelihood of answering questions by the member.

9. The method of claim 1, wherein the additional scores comprise an affinity score representing a likelihood of obtaining an answer to the question from the member based on an identity of an author of the question.

10. The method of claim 1, further comprising:
filtering the set of questions to remove content that is not appropriate for matching to the community of the members prior to calculating the relevance scores and the overall scores.

11. The method of claim 10, wherein the content comprises at least one of:
promotional content;
offensive content; and
factual questions.

12. The method of claim 1, wherein the member attributes comprise at least one of:
a skill;
a title;
a company;
an industry;
a school;
a location;
an interest;
a seniority; and
a group.

13. A system, comprising:
one or more processors; and
memory storing instructions that, when executed by the one or more processors, cause the system to:
obtain a set of questions from a community of members;
for each question in the set of questions:
use a set of tags for the question and member attributes for a member of the community to calculate a relevance score representing a relevance of the question to the member; and
combine the relevance score with additional scores for the member to obtain an overall score between the question and the member, wherein the additional scores are calculated based on interaction of the member with the community;
rank the set of questions by the overall scores; and
output the ranked set of questions to the member for use in obtaining answers to the set of questions from the member.

14. The system of claim 13, wherein the memory further stores instructions that, when executed by the one or more processors, cause the system to:
use one or more ranking factors to update the ranked set of questions prior to outputting the ranked set of questions to the member.

15. The system of claim 14, wherein the one or more ranking factors comprise at least one of:
responses to previous questions outputted to the member;
previous views of a question;
an author of the question;
previous interaction between the member and the author;
an explicit member preference; and
an implicit member preference.

16. The system of claim 13, wherein using the set of tags for the question and the member attributes for the member to calculate the relevance score representing the relevance of the question to the member comprises:
matching a subset of the tags for the question to one or more of the member attributes for the member;
for each tag in the subset of the tags, calculating a tag score for the tag based on a uniqueness of the tag across the community of members; and
combining tag scores for the subset of the tags with a set of weights to calculate the relevance score for the question.

17. The system of claim 13, wherein combining the relevance score with the additional scores for the member to obtain the overall score between the question and the member comprises:
summing the additional scores; and
multiplying the summed additional scores by the relevance score to obtain the overall score.

18. The system of claim 13, wherein the additional scores comprise at least one of:
an answer-quality score representing a quality of answers from the member;
an answer-propensity score representing a general likelihood of answering questions by the member; and
an affinity score representing a likelihood of obtaining an answer to the question from the member based on an identity of an author of the question.

19. A non-transitory computer-readable storage medium storing instructions that when executed by a computer cause the computer to perform a method, the method comprising:
obtaining a set of questions from a community of members;
for each question in the set of questions:
using a set of tags for the question and member attributes for a member of the community to calculate a relevance score representing a relevance of the question to the member; and
combining the relevance score with additional scores for the member to obtain an overall score between the question and the member, wherein the additional scores are calculated based on interaction of the member with the community;
ranking the set of questions by the overall scores; and
outputting the ranked set of questions to the member for use in obtaining answers to the set of questions from the member.

20. The non-transitory computer-readable storage medium of claim 19, wherein using the set of tags for the question and the member attributes for the member to calculate the relevance score representing the relevance of the question to the member comprises:
matching a subset of the tags for the question to one or more of the member attributes for the member;
for each tag in the subset of the tags, calculating a tag score for the tag based on a uniqueness of the tag across the community of members; and
combining tag scores for the subset of the tags with a set of weights to calculate the relevance score for the question.
